(19) United States
(12) Patent Application Publication
(10) Pub. No.: US 2025/0177922 A1
(43) Pub. Date: Jun. 5, 2025

(54) High efficiency utilization of heat in CO2 stripper

(71) Applicant: EIG, Inc., Sunnyvale, CA (US)

(72) Inventor: Eli Gal, Sunnyvale, CA (US)

(21) Appl. No.: 18/836,924

(22) PCT Filed: Feb. 3, 2023
(86) PCT No.: PCT/US2023/012336

§ 371 Date: Aug. 8, 2024

Related U.S. Application Data
(60) Provisional application No. 63/308,603, filed on Feb. 10, 2022.

(51) Int. Cl. B01D 53/96; B01D 53/14; B01D 53/34; B01D 53/52; B01D 53/62

(52) U.S. Cl. CPC B01D 53/96; B01D 53/1425; B01D 53/1468; B01D 53/1475; B01D 53/343; B01D 53/52; B01D 53/62

(57) ABSTRACT

In stripping volatile species in multi-species solutions. e.g. a CO₂-rich solution in a CO₂—NH₃—H₂O and CO₂—H₂S—NH₃—H₂O, evaporation starts at relatively low temperature depending on the pressure of the system. As CO₂ evaporates the boiling temperature of the solution increases. In current CO₂ stripper systems, all the external heat is provided at the high temperature in the reboiler. In this invention, external heat is provided to the solution at lower than the reboiler temperature through heat exchangers constructed in parallel to the regenerative heat exchanger. As a result, a much smaller heat input is required at the high temperature of the reboiler and, depending on the quality of the heat source, the reboiler may even be eliminated altogether. This allows for efficient use of various heat sources such as syngas, flue gas and hot oil from thermal solar collectors down to a lot lower temperature than achieved in a conventional system.

### FIELD OF THE INVENTION

The invention relates to a method and system for efficiently stripping CO₂ and H₂S (when present) from CO₂-rich solutions in the context of CO₂, capture. The system allows for the efficient use of multiple heat sources including low grade heat sources to lower the useful heat duty of the reboiler.

### BACKGROUND OF THE INVENTION

Capturing CO₂ from gases into absorbing solution and stripping the CO₂ is important in many industrial processes such as removing CO₂ from flue gas, natural gas, biogas and syngas and in the production of hydrogen, methanol and ammonia. These processes are well known and commercially available for many years and many of these processes are using amine compounds for the capturing of CO₂. The problem with all the CO₂ capture processes is that they are capital intensive and they consume a lot of electricity, heat and cooling water.

In a typical amine system, in syngas application for example, the CO₂-rich solution, collected at the bottom of the absorber, flows through counterflow Regenerative Heat Exchanger (RHE) where the CO₂-rich solution is heated by the CO₂-lean solution from the bottom of the stripper. With no or little evaporation the heat capacity of the hot solution is typically similar to the heat capacity of the colder solution and the temperature lost by the hot solution is similar to the temperature gain by the colder solution.

Due to the thermal instability of the various amine solvents the heat source to the reboiler in amine systems has to be at moderate and uniform temperatures and typically at less than 150 degrees Celsius. Saturated steam that condenses at uniform temperature is typically used as heat source.

The present invention is applicable to systems where the solvent is thermally stable and the desired specie, such as CO₂ in the CO₂—NH₃—H₂O system, starts evaporating at relatively low temperature including in the regenerative heat exchanger. The evaporation resulting in lower increase in temperature of the evaporating solution and allows for efficient utilization of variety of external heat sources with lower grade heat than required in the reboiler. Using the lower grade heat significantly reduces and can even eliminate the use of higher-grade heat in the reboiler.

### SUMMARY OF THE INVENTION

The present invention provides a process to strip CO₂ from CO₂-rich solution at high efficiency utilization of the heat using partially low-grade waste heat. The cool CO₂-rich stream is produced in the absorber in a CO₂ capture system. The process is designed in such a way that heating the colder CO₂-rich solution is achieved using heat from the hot CO₂-lean solution and in addition external low-grade heat source is used in parallel to the CO₂-len solution. This result in significant evaporation of CO₂ in the regenerative heat exchangers and a reduction in the reboiler heat duty to a degree that the reboiler is a lot smaller and in some cases, depending on the external heat source, it can be eliminated altogether.

To achieve the above, the CO₂-rich solution after being heated to close to its boiling temperature by the CO₂-lean solution is split and flows to 2 or more regenerative heat exchangers in parallel. The heat source to the parallel heating lines will be CO₂-lean solution and other low-grade heat sources.

### BRIEF DESCRIPTION OF THE DRAWINGS

FIG. 1 shows according to an exemplary embodiment of the invention a schematic of temperature profile in conventional regenerative heat exchanger in a stripper system (left) and in regenerative heat exchangers of the current invention (right).

FIGS. 2-3 show according to an exemplary embodiment of the invention schematic description of the process and system of the current invention showing two optional configurations of the regenerative heat exchangers arrangements.

### DETAILED DESCRIPTION

The present invention provides a system and process to strip CO₂ and H₂S (when present) from CO₂-rich solutions at high efficiency using relatively low-grade external heat in the regenerative heat exchangers.

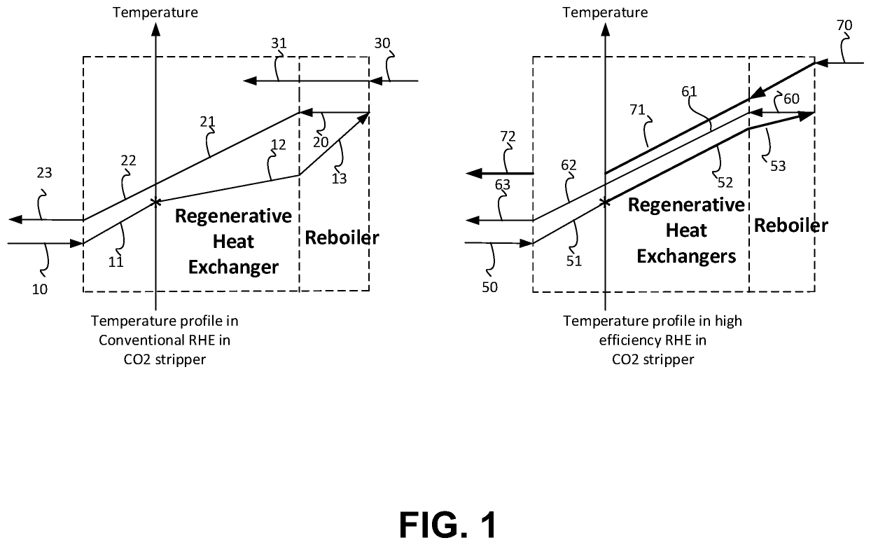

FIG. 1 shows the temperature profile in a regenerative heat exchanger and a reboiler in conventional CO₂ stripping system and in one or more regenerative heat exchangers of the current invention.

In the conventional system, a cooled CO₂-rich solution from the CO₂ absorber is heated by a CO₂-lean solution from the CO₂ stripper. In the colder stage of the heat exchanger, the CO₂-rich solution 10 is heated, stream 11, as it gains sensible heat, absorbed from the CO₂-lean solution 22, and it becomes warmer and reaching its initial boiling point. In the warmer stage of the heat exchanger the temperature of the solution 12 increases at a lower rate as CO₂ evaporates and the solution gains both sensible and latent heat. Heating is done by sensible heat from the CO₂-lean solution 21. The resultant warm CO₂-rich stream 13 is fed into the stripper where it gains additional heat in the stripper and in the reboiler while evaporating more CO₂ to become CO₂-lean solution, stream 20. All the external heat sources in the system is provided by typically condensing steam in the reboiler, stream 30, at temperature higher than the process side of the reboiler.

In the high efficiency regenerative heat exchanger of the current invention cooled CO₂-rich solution from the CO₂ absorber is heated by a CO₂-lean solution from the CO₂ stripper and in addition, the CO₂-rich solution is heated by heat from external heat source at lower grade, lower temperature, than the heat used in the reboiler. In the colder stage of the heat exchanger, as in the conventional system, the CO₂-rich solution 50 is heated, stream 51, as it gains sensible heat absorbed from the CO₂-lean solution 62, and it becomes warmer and reaching its initial boiling point. In the warmer stage of the heat exchanger the CO₂-rich solution is split into two or more smaller streams where heat is provided from both, the CO₂-lean solution 61 and from a warmer heat source 71. As a result of the additional external heat provided in the regenerative heat exchanger, the CO₂-rich solution evaporates more CO₂ and it becomes warmer in such a way that the CO₂-rich solution entering the stripper, Stream 53, is at temperature close to the temperature of the heat source in the reboiler and containing larger fraction of CO₂ vapor. The heat duty of the reboiler in significantly lower than in the conventional design and in some applications, such as in hydrogen and ammonia production plants, the reboiler may be eliminated altogether. The heat source to the reboiler, Stream 70, may be hot syngas, flue gas, oil and steam. As an example, in blue hydrogen and blue ammonia applications, Stream 70 is preferably syngas from the LTS reactor at 170-250 degrees Celsius is cooled to 140-200 degrees Celsius in the reboiler and further to 90-110 degrees Celsius in the regenerative heat exchanger. Typical temperature for the initial boiling temperature of the CO₂ rich solution is 80-100 degrees Celsius depending on the pressure, the ammonia concentration and the CO₂/NH₃ ratio of the CO₂-rich solution. In the conventional system, the heat of the syngas from the LTS and from other sources is used to generate low pressure steam that is then used to heat the solution in the reboiler. A lot less heat from the syngas is useful in the conventional design, the heat utilization is lower and additional heat exchangers surface area has to be used.

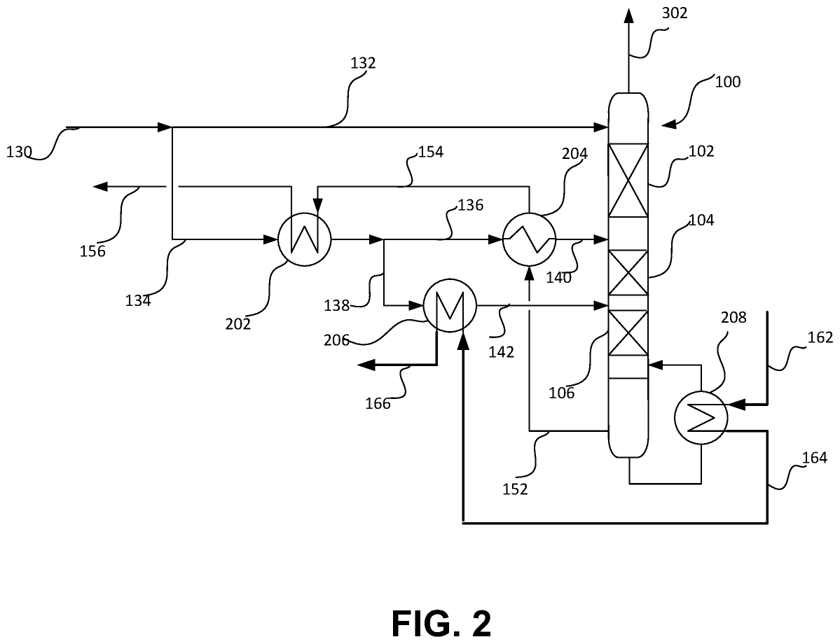

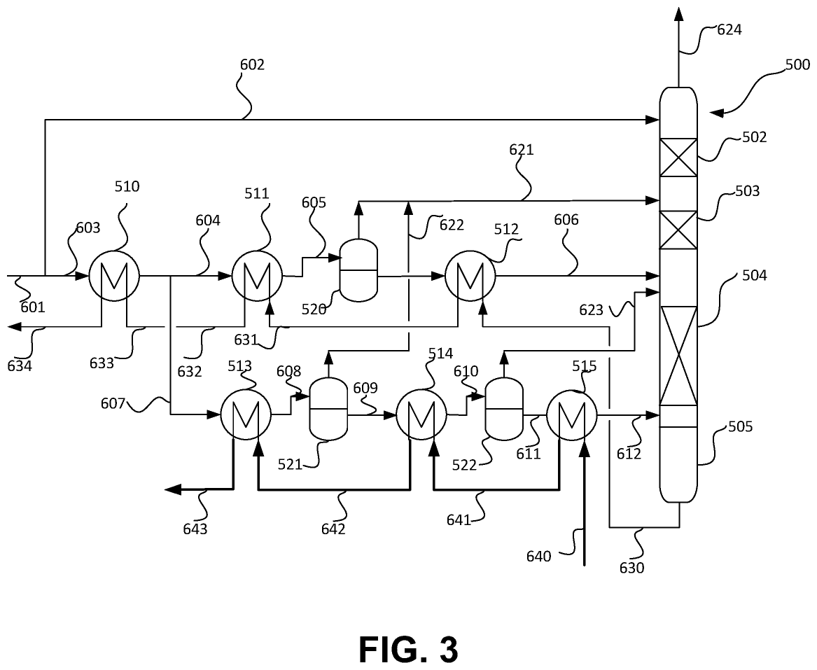

A schematic of the current invention process with two configurations of the regenerative heat exchanger system is shown in FIG. 2 and in FIG. 3. Optimization of capex and Opex may result in addition configuration all based on the principles of the current invention of splitting the CO₂ rich solution at or near the starting boiling temperature of the solution as shown in FIG. 1.

In FIG. 2 the stripper is vessel 100 comprises of packed tower sections 102, 104 and 106, regenerative heat exchangers 202, 204 and 206 and a reboiler 208. A stream of CO₂-rich solution from the absorber, Stream 130, is fed to the stripper vessel 100 in one or few different elevations through a series of regenerative heat exchangers. Stream 130 is at pressure in the range of 10-60 bara and it splits into two smaller streams:
Stream 132, about 3-10% of the total, is fed at the absorber bottom temperature to the top of the absorber and it is used to cool the CO₂ gas stream and to capture and condense ammonia and water vapor from the gas stream.
Stream 134, the balance of stream 130, is fed to regenerative heat exchanger 202 where it is heated by CO₂-lean solution 154 to close to its boiling temperature and the cooled CO₂-lean solution 156 is sent to the absorber system.

The heated CO₂-rich solution further splits into two smaller streams
Stream 136 which is further heated in regenerative heat exchanger 204 by the hot CO₂-lean solution 152 from the bottom of the stripper. The size of stream 136 is calculated such that the heat required to evaporate CO₂ and to elevate its temperature to as close as practical to the temperature of the CO₂-lean solution 152 is similar to the heat recovered from the entire CO₂-lean solution as it is cooled from its temperature at the bottom of the stripper to temperature close to the temperature of the CO₂-rich solution from heat exchanger 202.
Stream 138 which is further heated in regenerative heat exchanger 206 by the heat source that was used in the reboiler such as syngas 162. The cooled syngas from the reboiler 164 is at higher temperature than the CO₂-lean solution from the stripper 152 and it is a heat source for heating stream 138.

The two hot CO₂-rich streams 140 and 142 are at higher temperature and contain a lot more CO₂ in gas phase than in conventional design and as a result, reduce the heat duty of the reboiler 208 which utilizes a lot less of the highest-grade heat in the system required to produce steam in conventional designs.

The cooled syngas 166 after cooling in the reboiler 208 and heat exchanger 206 is further cooled, its water content is condensed and recovered from the gas and the cooled gas is sent to the absorber for CO₂ capture.

The stripper itself is a multistage packed tower designed to optimize CO₂ stripping and to minimize the content of the contaminants in the CO₂ stream. The stripper has a distinct temperature profile it is relatively cold at the top with temperature increasing at lower levels to the maximum temperature at the bottom of the stripper. The CO₂ from the stripper, stream 302, is at pressure and contains low concentration of ammonia and water vapor.

Another embodiment of the invention is shown in FIG. 3. It shows a system where all the heat is introduced in the regenerative heat exchanger system and the stripper vessel is a flash vessel for separation of the gas and liquid and for cooling the gas stream at the top of the stripper such that it exits the stripper cooled and with low concentration of ammonia and water vapor.

In FIG. 3 stripper vessel 500 has packed tower sections 502, 503 and 504, regenerative heat exchangers 510, 511 and 512 to recover heat from the CO₂-lean solution, heat exchangers 513, 514 and 515 to extract heat from external heat source, such as hot syngas in stream 640, flash vessels 520, 521 and 522 to separate the CO₂-rich solution from the gas stream generated by evaporation in the heat exchangers. There is no reboiler in FIG. 3 but one can be added if even more CO₂-lean solution is required. Low temperature CO₂-rich solution from the absorber, Stream 601, is fed to the stripper vessel 500 in few different elevations in the stripper after flowing through series of heat exchangers. Stream 601 is at pressure in the range of 10-60 bara and it splits into two smaller streams:
Stream 602, about 3-10% of the total, is fed cold to the top of the absorber and it is used to cool the CO₂ gas stream and to capture and condense ammonia and vapor from the gas stream.
Stream 603, the balance of stream 601, is fed to regenerative heat exchanger 510 where it is heated by CO₂-lean solution 633 to close to its boiling temperature and the cooled CO₂-lean solution 634 is sent to the absorber system.

The heated CO₂-rich solution further splits into two smaller streams.
Stream 604 which is further heated in regenerative heat exchanger 511 by the hot CO₂-lean solution 631 from the bottom of the stripper. The flow rate of stream 604 is calculated to minimize the temperature difference between the hot CO₂-lean solution 630 and the CO₂ rich solution 606 that is splashed into the stripper. The heated stream from heat exchanger 511 contains vapor phase which is mainly CO₂ and it is splashed into separation vessel 520 where the gas component flows to the colder zone of the stripper while the solution, now depleted of a fraction of its CO₂, is sent to a second heat exchanger 512 where it is further heated to as practically closed to the temperature of the heating CO₂-lean solution 630. The resultant two-phase stream 606 is fed to the stripper.
Stream 607 which is further heated in heat exchanger 513 by relatively low-grade heat, in heat exchanger 514 by higher grade heat and in heat exchanger 515 by yet higher-grade heat. Two-phase solution exits from each of the heat exchangers and it is fed to separation vessels 521 and 522 with the gas phase directed to colder zones of the stripper. The solution cascades through the heat exchangers and separation vessels and it is fed to the stripper at the bottom as shown. The heat source 640 can be any hot fluid such as syngas from the reformer, downstream of the shift reactors, hot flue gas, hot heating oil, hot fluid from thermal solar system and steam. Multiple heat sources can optionally be used and they can be injected separately to each heat exchanger.

The two hot CO₂-rich solutions 606 and 612 and the gas stream 621 and 623 fed to the stripper contain a lot more heat than conventional design and, depending on the external heat source, can be sufficient to strip the designed CO₂ without the need for a reboiler.

In syngas application, the cooled syngas 643 is further cooled to about ambient temperature, its water content is recovered and it is fed to the absorber for capturing its CO₂ content.

The stripper itself is a multistage packed tower designed to optimize CO₂ stripping and to minimize the content of the contaminants in the CO₂ stream. The stripper has a distinct temperature profile. It is cold at the top with temperature increasing at lower levels to the maximum temperature at the bottom of the stripper. The CO₂ from the stripper, stream 624, is at pressure and contains low concentration of ammonia and water vapor.

An example of how the process can be used in ammonia plant using the design shown in FIG. 2. In the ammonia plant of the example the flow rate of the syngas from the LTS reactor is 440,000 Kg/h, the pressure is 38 Barg, the temperature 220 degrees Celsius and the gas contains 13% CO2, 23% H₂O vapor and the balance is mainly hydrogen and nitrogen. The syngas heat can be used to, for example, raise low pressure steam in a steam boiler (not shown in FIG. 2) to lower the gas temperature to 172 degrees Celsius. The cooled gas, stream 162, has sufficient heat content to strip the CO₂ with no need for steam or other heat source. The syngas from stream 162 is cooled in reboiler 208 to 142 degrees Celsius by transferring heat to the process solution.

The cooler stream 164 flows to the counter current heat exchanger 206 where it heats a portion of the CO₂ rich solution as it is cooled to 102 degrees Celsius, Stream 166. Syngas 166 is further cooled to above ambient temperature and it flows to the absorber.

The CO₂ rich solution in the example, Stream 130, flow rate is 1,135,000 Kg/h containing 10 molal ammonia and high concentration of CO₂ captured in the absorber at temperature of 65 degrees Celsius. About 10% of stream 130 or 115,000 Kg/h is sent to the top of the absorber, stream 132, and the balance, stream 134 with flow rate of 1,020,000 Kg/h is sent to heat exchanger 202 where it is heated to 88 degrees Celsius by heat from the CO₂ lean solution, stream 154. The heated stream from heat exchanger 202 is split to streams 136 containing ⅔ of the mass of stream 134 and stream 138 containing ⅓ of the total. Stream 136 is heated by the CO₂ lean stream 152 from the reboiler in heat exchanger 204 to 139 degrees Celsius with gas phase, mainly CO₂, amounting to 6.5 mol % of the total stream. Stream 138 is heated in heat exchanger 206 to 136 degrees Celsius and the stream contains 5.8 mol % gas phase mainly CO₂. The 169 Mton/h CO₂ regenerated in the process, stream 302, is high purity CO₂ with low moisture content. The heat consumed to regenerate the CO₂ amounts to 0.94 GJ/Mton in the reboiler 208 using a portion of the syngas heat and 0.7 GJ/Mton in heat exchanger 206 using syngas heat down to 102 degrees Celsius. Total heat consumption of the process is 1.64 GJ/Mton of which 100% comes directly from the syngas at relatively low temperature that otherwise would be wasted.

What is claimed is:

1. A method for minimizing energy consumption for CO₂ stripping, comprising:
(a) having a CO₂ rich solution from a CO₂ absorber, wherein the CO₂ rich solution comprises species with different degrees of volatility and the CO₂ having the highest degree of volatility;
(b) having a stripper vessel with a temperature profile designed in such a way that a top of the stripper vessel is relatively cold and a bottom of the stripper vessel is relatively hot;
(c) having a series of heat exchangers external to the stripper vessel, wherein the CO₂ rich solution is split at the point where boiling of the solution starts to the series of heat exchangers, wherein output of the series of heat exchangers feeds into the stripper vessel at different stages of the stripper vessel with colder streams feed at higher elevations of the stripper vessel and warmer streams at lower elevation of the stripper vessel, and wherein the series of heat exchangers are designed for heating the CO₂ rich solution and evaporating mainly CO₂ from the CO₂ rich solution;
(d) producing a CO₂ lean solution by the stripper vessel stripping more CO₂ from the semi-lean CO₂ solution using heat input from the series of heat exchangers; and
(e) producing CO₂ by the stripper vessel stripping CO₂ from the CO₂ rich solution and input from the series of heat exchangers and the series of heat exchangers.

2. The method as set forth in claim 1, further comprising after step 1(c) producing a semi-lean CO₂ solution from the CO₂ rich solution by the evaporation of mainly CO₂ in the series of heat exchangers, wherein step 1(e) is then defined as producing a CO₂ lean solution by the stripper vessel stripping more CO₂ from the semi-lean CO₂ solution using heat input from the series of heat exchangers.

3. The method as set forth in claim 1, wherein the series of heat exchangers comprises at least one reboiler.

4. The method as set forth in claim 1, wherein the CO₂ rich solution comprises CO₂ or CO₂ and H₂S and additionally less volatiles species such as NH₃ and H₂O.

5. The method as set forth in claim 1, further comprising heating the CO₂ rich solution with one or more of external heat sources.

6. The method as set forth in claim 5, wherein one or more of the external heat sources is syngas from a natural gas reformer, coal, or biomass gasification.

7. The method as set forth in claim 5, wherein one or more of the external heat sources is hot oil.

8. The method as set forth in claim 5, wherein one or more of the external heat sources is from thermal solar collectors.

9. The method as set forth in claim 5, wherein one or more of the external heat sources is flue gas or hot air.
